(19) United States
(12) Patent Application Publication
(10) Pub. No.: US 2014/0160767 A1
(43) Pub. Date: Jun. 12, 2014

(54) OPTICAL LENS AND LIGHTING DEVICE HAVING SAME

(71) Applicant: HON HAI PRECISION INDUSTRY CO., LTD., New Taipei (TW)

(72) Inventor: PO-CHOU CHEN, New Taipei (TW)

(73) Assignee: HON HAI PRECISION INDUSTRY CO., LTD., New Taipei (TW)

(21) Appl. No.: 13/746,314

(22) Filed: Jan. 22, 2013

(30) Foreign Application Priority Data
Dec. 11, 2012 (TW) 101146504

(51) Int. Cl. F21V 5/00

(52) U.S. Cl. CPC F21V 5/002
USPC 362/308; 362/335; 362/327; 362/311.02

(57) ABSTRACT

An optical lens for adjusting lighting angle of a light emitting diode includes a bottom surface, a light incident surface and a light emitting surface. The light incident surface is formed in a middle portion of the bottom surface. The light incident surface is concaved from the bottom surface and forms a receiving chamber. The light incident surface has an ellipsoidal shape and a major axis of the light incident surface is coincided with an optical axis of the optical lens. The light emitting surface protrudes in a direction away from the bottom surface. The light emitting surface has an ellipsoidal shape and a major axis of the light emitting surface is perpendicular with the optical axis of the optical lens. A lighting device having the optical lens and the light emitting diode is also provided.

### BACKGROUND

1. Technical Field

The disclosure generally relates to an optical lens, and particularly relates to an optical lens to increase a lighting angle of a light source and a lighting device having the optical lens.

2. Description of Related Art

In recent years, due to excellent light quality and high luminous efficiency, light emitting diodes (LEDs) have increasingly been used as substitutes for incandescent bulbs, compact fluorescent lamps and fluorescent tubes as light sources of illumination devices.

Generally, light intensity of a light emitting diode gradually decreases from a middle portion to lateral sides thereof. However, in many applications, people want to obtain a light emitting diode with a wide lighting angle.

What is needed, therefore, is an optical lens and a lighting device having the optical lens to overcome the above described disadvantages.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is an isometric view of an optical lens in accordance with an embodiment of the present disclosure.

FIG. 2 is an inverted, isometric view of the optical lens in FIG. 1.

FIG. 3 is a cross sectional view of the optical lens in FIG. 1, taken along a line III-III.

FIG. 4 is a cross sectional view of a lighting device having the optical lens in FIG. 1.

### DETAILED DESCRIPTION

Embodiments of an optical lens and a lighting device will now be described in detail below and with reference to the drawings.

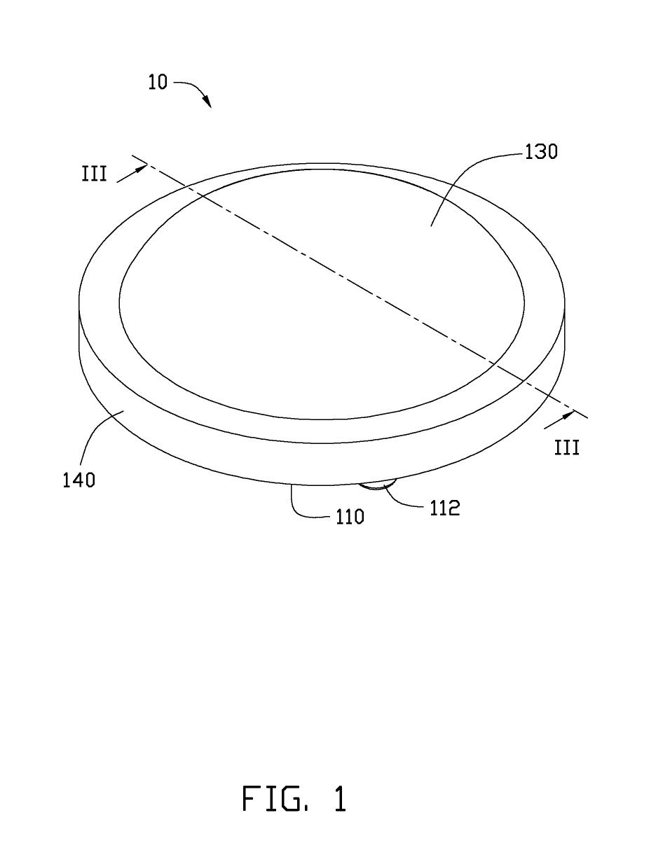

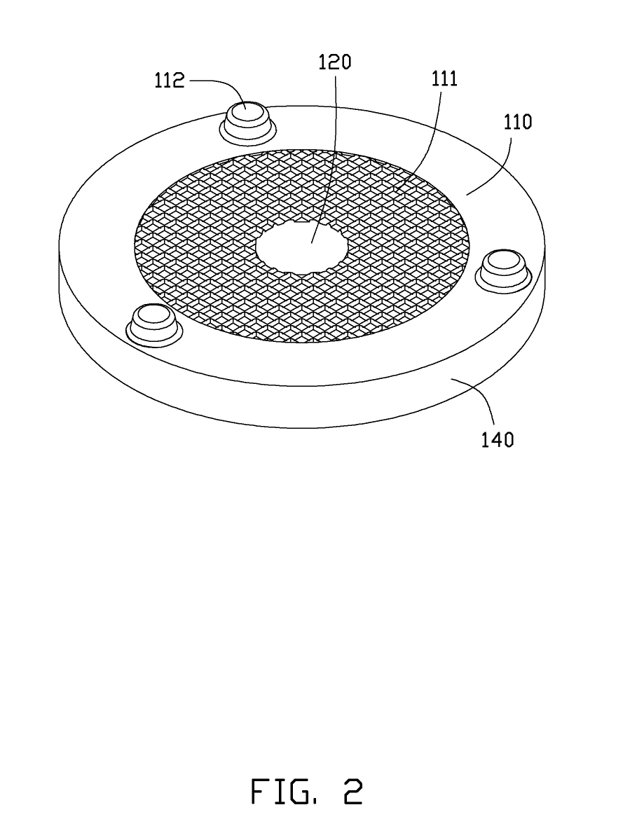

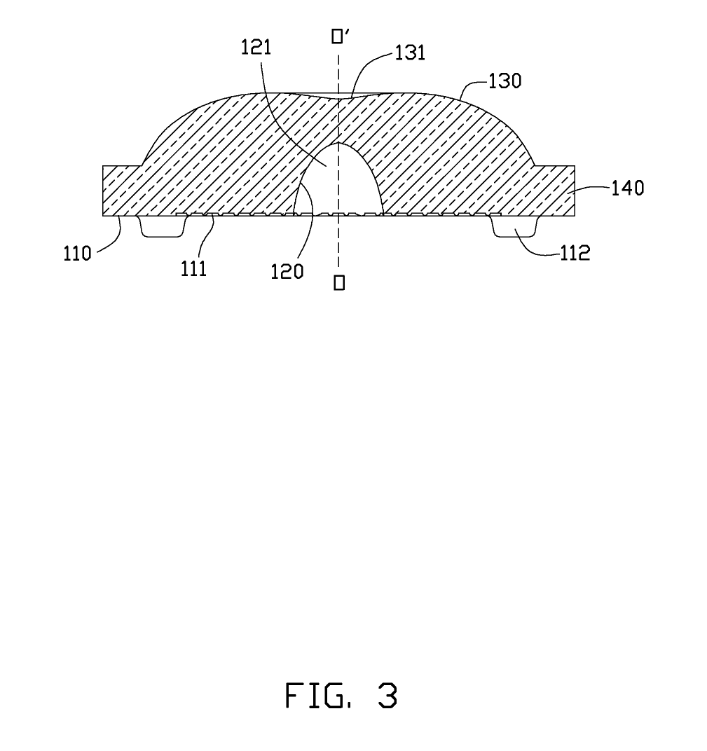

Referring to FIGS. 1-3, an optical lens 10 in accordance with an embodiment is provided. The optical lens 10 is made of a material selected from a group consisting of polycarbonate (PC), polymethyl methacrylate (PMMA) and glass. The optical lens 10 includes a bottom surface 110, a light incident surface 120 and a light emitting surface 130. The optical lens 10 has an optical axis OO′. In this embodiment, the optical lens 10 is axisymmetric around the optical axis OO′.

The light incident surface 120 is formed in a middle portion of the bottom surface 110 and concave from the bottom surface 110 to form a receiving chamber 121. The light incident surface 120 has an ellipsoidal shape and a major axis of the light incident surface 120 is coincided with the optical axis OO′ of the optical lens 10.

The light emitting surface 130 protrudes in a direction away from the bottom surface 110. The light emitting surface 130 also has an ellipsoidal shape and a major axis of the light emitting surface 130 is perpendicular to the optical axis OO′ of the optical lens 10. Preferably, the light emitting surface 130 can further define a recess 131 in a middle portion thereof. The recess 131 is extending from the light emitting surface 130 towards the bottom surface 110. A bottom end of the recess 131 is located at the optical axis OO′.

Preferably, the optical lens 10 further includes a side surface 140. The side surface 140 is connected between the bottom surface 110 and the light emitting surface 130. In this embodiment, the side surface 110 is vertical to the bottom surface 110.

Preferably, a plurality of micro-concaves 111 are formed on the bottom surface 110 of the optical lens 10, wherein the micro-concaves surround the light incident surface 120. The micro-concaves 111 are configured to reflect light therefore helping light in the optical lens 10 to emit outside the optical lens 10 via the light emitting surface 130.

Preferably, the optical lens 10 further includes three or more supports 112. The supports 112 are formed at the bottom surface 110 of the optical lens 10 and located at a periphery of the bottom surface 110, avoiding the micro-concaves 111.

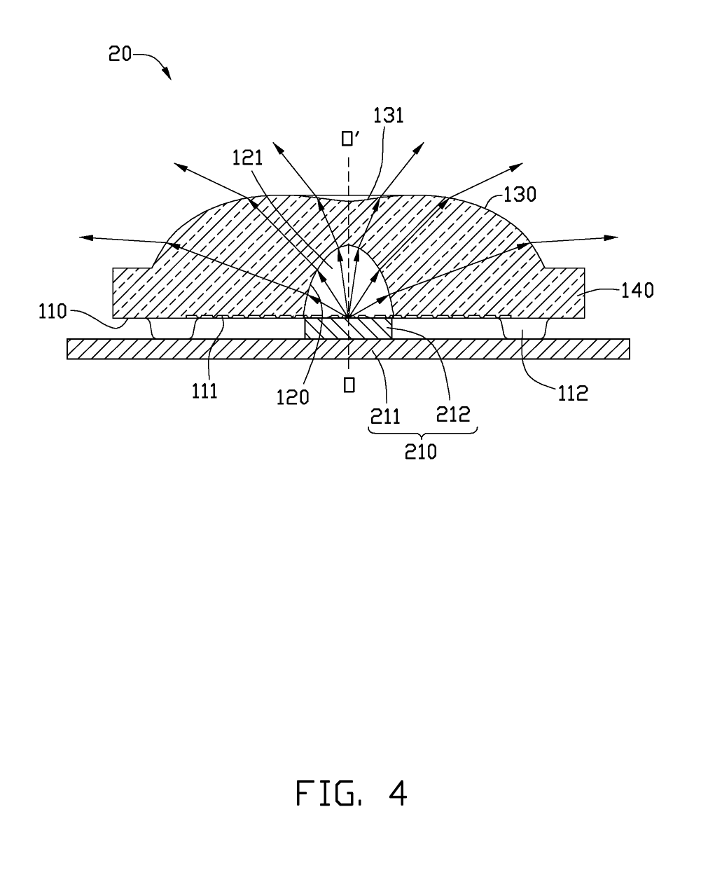

FIG. 4 shows a lighting device 20 having the optical lens 10 described above. The lighting device 20 includes the optical lens 10 and a lighting module 210. The lighting module 210 includes a substrate 211 and a light emitting diode 212 formed on the substrate 211. A light emitting surface (i.e., an upper surface) of the light emitting diode 212 is received in the receiving chamber 121 formed by the light incident surface 120. The supports 112 are mounted on an upper surface of the substrate 211 to position the optical lens 10 to the lighting module 210. In this embodiment, the bottom surface 110 of the optical lens 10 is supported by the supports 112 and coplanar with the upper surface of the light emitting diode 212. In operation, the light emitting diode 212 is powered to emit light. Light from the light emitting diode 212 emits into the optical lens 10 by the light incident surface 120, and emits into an outer environment from the light emitting surface 130 and the side surface 140.

In the optical lens 10 and the lighting device 20 described above, because the light incident surface 120 has an ellipsoidal shape and the major axis of the light incident surface 120 is coincide with the optical axis OO′ of the optical lens 10, when light from the light emitting diode 212 emits into the optical lens 10 from the light incident surface 120, the light will be refracted by the light incident surface 120 and emits in a direction away the optical axis OO′. Similarly, because the light emitting surface 130 has an ellipsoidal shape and the major axis of the light emitting surface 130 is perpendicular to the optical axis OO′, when light is emitting outside from the light emitting surface 130, the light will be further refracted by the light emitting surface 130 and emits in a direction further away the optical axis OO′. After refracted by the light incident surface 120 and the light emitting surface 130, light from the light emitting diode 212 will emit in a direction sufficiently away from the optical axis OO′. Therefore, a lighting angle of the light emitting diode 212 is increased.

It is to be further understood that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. An optical lens for increasing lighting angle of light from a light emitting diode, comprising:
a bottom surface;
a light incident surface formed in a middle portion of the bottom surface, the light incident surface concaved from the bottom surface and forming a receiving chamber configured for receiving a light emitting surface of the light emitting diode, the light incident surface being an ellipsoidal shape and a major axis of the light incident surface being coincide with an optical axis of the optical lens; and
a light emitting surface opposite to and protruding in a direction away from the bottom surface, the light emitting surface has an ellipsoidal shape and a major axis of the light emitting surface being perpendicular with the optical axis of the optical lens.

2. The optical lens of claim 1, wherein the light emitting surface defines a recess in a middle portion thereof, and the recess extends from the light emitting surface towards the bottom surface, a bottom of the recess being at the optical axis of the optical lens.

3. The optical lens of claim 1, further comprising a side surface, the side surface being connected between the bottom surface and the light emitting surface.

4. The optical lens of claim 3, wherein the side surface is vertical to the light emitting surface.

5. The optical lens of claim 1, wherein a plurality of micro-concaves is formed on the bottom surface of the optical lens, and the micro-concaves surround the light incident surface.

6. The optical lens of claim 1, further comprising three or more supports, the supports being formed on the bottom surface of the optical lens and located at a periphery of the bottom surface.

7. A lighting device, comprising:
an optical lens comprising a bottom surface, a light incident surface and a light emitting surface, the light incident surface being formed in a middle portion of the bottom surface, the light incident surface concaved from the bottom surface and forming a receiving chamber, the light incident surface being an ellipsoidal shape and a major axis of the light incident surface being coincide with an optical axis of the optical lens, the light emitting surface being opposite to and protruding in a direction away from the bottom surface, the light emitting surface has an ellipsoidal shape and a major axis of the light emitting surface being perpendicular with the optical axis of the optical lens; and
a lighting module comprising a substrate and a light emitting diode formed on the substrate, an upper light emitting surface of the light emitting diode being received in the receiving chamber formed by the light incident surface, light from the light emitting diode emitting into the optical lens via the light incident surface and emitting out of the optical lens via the light emitting surface.

8. The lighting device of claim 7, wherein the light emitting surface defines a recess in a middle portion thereof, and the recess extends from the light emitting surface towards the bottom surface.

9. The lighting device of claim 7, wherein the optical lens further comprises a side surface, the side surface being connected between the bottom surface and the light emitting surface.

10. The lighting device of claim 9, wherein the side surface is vertical to the light emitting surface.

11. The lighting device of claim 7, wherein a plurality of micro-concaves is formed on the bottom surface of the optical lens, and the micro-concaves surround the light incident surface.

12. The lighting device of claim 7, wherein the optical lens further comprises at least three supports, the at least three supports being formed on the bottom surface of the optical lens and located at a periphery of the bottom surface, the at least three supports being mounted on an upper surface of the substrate, the bottom surface of the optical lens being supported by the at least three supports and coplanar with the upper light emitting surface of the light emitting diode.
